(19) United States
(12) Patent Application Publication
(10) Pub. No.: US 2026/0113278 A1
(43) Pub. Date: Apr. 23, 2026

(54) METHOD FOR MANAGING DATA TRAFFIC BETWEEN A SOURCE ENTITY AND A RECIPIENT ENTITY, AND CORRESPONDING ENTITY AND COMPUTER PROGRAM

(71) Applicant: Orange, Issy-Les-Moulineaux (FR)

(72) Inventors: Mohamed BOUCADAIR, Chatillon Cedex (FR); Christian JACQUENET, Chatillon Cedex (FR)

(21) Appl. No.: 19/116,973

(22) PCT Filed: Sep. 27, 2023
(86) PCT No.: PCT/EP2023/076689

§ 371 Date: Mar. 28, 2025

(30) Foreign Application Priority Data
Sep. 30, 2022 (FR) FR2210007

(51) Int. Cl. H04L 47/2475

(52) U.S. Cl. CPC H04L 47/2475

(57) ABSTRACT

A method of managing data traffic between a source entity and a recipient entity, and corresponding entity and computer program. The method is for managing data traffic between a source entity and a recipient entity, implementing the following steps: selecting, for the source entity and the recipient entity, at least one policy for scheduling application data packets exchanged between the source entity and the recipient entity, taking into account at least one characteristic of an application associated with the application data, and establishing at least one connection between the source entity and the recipient entity, on which the at least one selected packet scheduling policy is implemented.

### CROSS-REFERENCE TO RELATED APPLICATIONS

This application is filed under 35 U.S. C. § 371 as the U.S. National Phase of Application No. PCT/EP2023/076689 entitled “Method For Managing Data Traffic Between A Source Entity and A Recipient Entity, and Corresponding Entity and Computer Program” and filed Sep. 27, 2023, and which claims priority to FR2210007 filed Sep. 30, 2022, each of which is incorporated by reference in its entirety.

### BACKGROUND

### Field

The field of the invention is that of communications within a network, for example, a computer network implementing the IP protocol, such as a WAN (Wide Area Network) network.

More specifically, the invention proposes a solution for improving the exchange of data between a source entity and a recipient entity connected to said network.

The invention notably has an application, but not exclusively, in a network based on an SD-WAN (Software-Defined Wide Area Network) architecture.

### Prior Art

A WAN network can notably be used to interconnect the various sites of a company, each site hosting at least one LAN (Local Area Network) network.

Typically, such a WAN network is based on the use of the MPLS (Multi Protocol Label Switching) protocol, that supports communications established between the various sites and provides, for example, access to local applications hosted on a server of the company from one or other of the remote sites.

Congestion phenomena can occur in the WAN network depending on uses, on user behaviour or even on the nature of the applications or content that users want to access. These applications or content can be hosted in cloud infrastructures.

New techniques for automating network resource production and use procedures have been introduced recently. In particular, SDN (Software-Defined Networks) network architectures have been deployed, in which a typically centralised computing logic (for example, an SDN controller) is responsible for dynamically allocating the resources involved in routing traffic or in providing the communication service(s) supported by the network. In particular, these automation techniques significantly improve the flexibility of use of the resources and their adaptability to user needs.

Such a flexibility thus makes it easier to allocate network resources on demand, manage the application flows of a company or yet maintain the continuity of a communication service in the event of a transmission resource failure, for example.

Communication services such as virtual private network (VPN) services can notably be deployed on SD-WAN infrastructures that make it easier to establish IPsec tunnels between the sites of a company that are interconnected via the VPN, for example.

Similarly, SD-WAN architectures make it easier to manage the application flows of a company, some of whose resources can be hosted in private, public or hybrid cloud infrastructures.

However, managing the traffic to or from a site of a company is often conditioned by changes in network access conditions, the availability of one or more network access paths, changes in traffic volume over time, the pricing conditions for accessing the network(s) or establishing data transport facilities, the confidentiality of the information exchanged between sites, etc.

Yet, such parameters are not always known to the computing logic used by the SD-WAN infrastructure operator, which can notably lead to non-optimised engineering for routing data traffic.

Solutions have thus been proposed for predictive management of the quality of experience. These solutions are based on the use of artificial intelligence (AI) techniques such as machine learning, and generally involve entities external to a network, such as an SDN controller.

However, these solutions involve the exchange of large volumes of telemetry data, which could be used for malicious purposes. In addition, due to the use of external entities notably, the aggregation and centralisation of data also present security vulnerabilities that could be exploited for hacking or profiling purposes. These types of engineering thus raise security and confidentiality issues.

There is therefore a need for a new data traffic management technique, that can notably be applied to the management of the traffic routed over an SD-WAN infrastructure, and that makes it possible to overcome at least some of the drawbacks of the prior art.

### SUMMARY

The invention proposes a solution in the form of a method for managing data traffic between a source entity and a recipient entity, implementing:
selecting, for said source entity and said recipient entity, at least one policy for scheduling application data packets exchanged between said source entity and said recipient entity, taking into account at least one characteristic of an application associated with said application data, said at least one selected packet scheduling policy being supported by said source entity and by said recipient entity,
establishing at least one connection between said source entity and said recipient entity, on which said at least one selected packet scheduling policy is implemented.

Such a method for managing data traffic according to at least one embodiment of the invention thus makes it possible to take into account the nature of the applications or data flows exchanged between a source entity and a recipient entity to choose the packet scheduling policy to be executed for a given connection (referred to as the reference connection) established between this source entity and this recipient entity. This approach differs from the state of the art where the configuration of the packet scheduling policy is local to a device and cannot be negotiated per connection or at the level of the network linking the source entity and the recipient entity.

Indeed, such applications can have particular characteristics, for example a type of applications, constraints or needs in terms of quality of service or experience, or in terms of security (maximum transit time between two local area networks, each associated with one site of a company, for example, packet loss rate, maintaining the confidentiality of the information exchanged between certain sites, etc.). They can also have constraints or needs in terms of pricing or consumption (pricing optimisation per access, consumption monitoring, etc.). Thus, taking into account at least one characteristic related to an application makes it possible to select a packet scheduling policy suitable for the traffic profile characteristic of said application, and intended to optimise the routing of the data characteristic of this application between the source entity and the recipient entity.

It should be noted that the proposed solution is also applicable to point-to-multipoint (for example, in the case of a television programme broadcasting service based on multicast transmission mode) or multipoint-to-multipoint (for example, in the case of a videoconferencing service) connections. In this case, the reference connection can be established between at least one source entity and at least one recipient entity.

According to a particular embodiment, packet scheduling policies local to each network are selected (rather than a common policy applied to all traffic routed over a WAN network), which makes it possible to retain some control over the routing of data and the routes selected to route them between the various sites.

These local packet scheduling policies can thus resonate in the engineering choices related to the establishment of inter-site transport resources.

For example, such packet scheduling policies belong to the group comprising:
a path management policy,
a congestion management policy,
a packet reassembly policy,
a packet reordering policy,
etc.

It should be noted that such a method according to the invention can be implemented indifferently by the source entity and/or by the recipient entity.

More generally, such a method is applicable to any communication network justifying the execution of packet scheduling policies (intended to optimise packet routing) capable of taking into account the previously mentioned application constraints or needs. In particular, such a method can be applied by a wide area network based on an SD-WAN architecture.

Such a traffic management method, which can be used to improve the quality of user experience for example, is referred to as SCHEMATICS (“Procedure for SCHEdule Management for Technically-advanced InfrastruCtureS”) in the remainder of the description.

A data packet scheduling policy is referred to as PSS (Packet Schedule SCHEMATICS) hereafter.

In a particular embodiment, the source entity can transmit to the recipient entity a list of at least one packet scheduling policy supported by said source entity.

In another embodiment (that can be combined with the particular embodiment above), the source entity receives, from the recipient entity, a list of at least one packet scheduling policy supported by said recipient entity.

The source entity and/or the recipient entity can thus check whether they support at least one common packet scheduling policy. The two entities can also indicate a preference that can be taken into account for the selection of a scheduling policy for a current connection.

For example, according to a particular embodiment, the source entity can check whether the recipient entity supports a packet scheduling policy preferred by the source entity. If this is not the case, the source entity can check whether the recipient entity supports at least one packet scheduling policy supported by the source entity. If such is not the case, the management method according to the invention cannot be implemented.

The source, resp. recipient, entity can thus store in a memory a table recording all packet scheduling policies supported by the recipient, resp. source, entity. This table is maintained by the source (res. recipient) entity.

Such lists can notably be transmitted using a transport layer protocol between the source entity and the recipient entity. For example, the QUIC, TCP (with or without the MPTCP option) protocols can be used. These parameters can also be exchanged using a protocol such as GRE, GTP, IKE, etc.

If the QUIC protocol is used, a new QUIC frame is defined to include the PSS information. This new QUIC frame, referred to as a PSS frame, can be sent by the source entity, using a secure connection between the source entity and the recipient entity, to trigger the sending by the recipient entity of the list of PSS(s) supported by the recipient entity.

In a particular embodiment, said source, resp. recipient, entity transmits a parameter informing the recipient, resp. source, entity that it is capable of implementing said at least one selected packet scheduling policy.

For example, such a parameter takes a first value to indicate that the entity transmitting this parameter (source entity or recipient entity) supports the procedure for selecting at least one packet scheduling policy, and a second value to indicate that the entity transmitting this parameter (source entity or recipient entity) does not support the procedure for selecting at least one packet scheduling policy.

As a variant, the absence of such a parameter means that the procedure for selecting at least one packet scheduling policy is not supported by the entity that sent the message.

Such a parameter can notably be transmitted using a transport layer protocol between the source entity and the recipient entity. The same protocol among those previously mentioned by way of examples and used to transmit the lists proposed above can be used.

If the QUIC protocol is used, such a parameter can be a QUIC transport parameter referred to herein as “Customized_PSS”, set to “0×1” for example, to indicate that the entity transmitting the QUIC PSS frame comprising such a parameter supports the method according to the invention. The “Customized_PSS” parameter can be set to “0×0” for example to indicate that the entity transmitting the QUIC PSS frame does not support the method according to the invention.

In a particular embodiment, said connection comprises at least two sub-connections each associated with a separate path between said source entity and said recipient entity, and said source entity sends said application data over at least one of said sub-connections, taking into account said at least one packet scheduling policy selected for said connection.

According to this particular embodiment, the establishment of sub-connections corresponding to the reference connection established between the source and recipient entities, also referred to as a multi-path connection, enables all or part of the traffic to be switched or redirected to one path or another, for example depending on the quality of service or quality of experience objectives set/observed for an application, or depending on changes in the application data routing conditions (deterioration in transit time, etc.).

For example, according to the selected packet scheduling policy, various procedures for processing the application data packets can be implemented when establishing the connection, enabling traffic to be sent over one and/or other of the paths.

In a particular embodiment, the method for managing data traffic comprises the reception, by the source entity and/or the recipient entity, of at least one item of traffic classification information enabling at least one packet scheduling policy to be associated with a type of application.

Such classification information notably makes it possible to associate an application, or more generally a type of application, with at least one packet scheduling policy that satisfies the needs and/or constraints of such a type of application (for example, in terms of quality of service or experience). The step of selecting a packet scheduling policy can notably take into account such classification information. An application can communicate via a dedicated transport API to facilitate the selection of a PSS policy to be implemented for establishing an underlying transport connection.

According to a particular characteristic, the application mode of said at least one selected packet scheduling policy (that is, the way application data packets are handled, for example, configuration and queue management) is updated periodically and/or depending on changes in the routing conditions of the application data exchanged between said source entity and said recipient entity.

In this way, it is possible to perform actions compliant with the selected packet scheduling policy, for example to switch or redirect traffic to one path or another, or mark certain application data packets, notably depending on the quality of service or quality of experience objectives set for the application considered.

According to a first embodiment, the source entity is a first device connected to a local area network, and the recipient entity is a second device connected to an external network. As a variant, the source entity is a second device connected to an external network and the recipient entity is a first device connected to a local area network.

According to this first example, the proposed solution is implemented directly by the first device, for example a terminal, and the second device, for example a remote server.

According to a second embodiment, the source entity is an access device connected to a local area network and to at least one external network, routing application data from a first device connected to the local area network, and the recipient entity is a second device connected to at least one external network. As a variant, the source entity is a second device connected to at least one external network and the recipient entity is an access device connected to a local area network and to at least one external network, routing application data to a first device connected to the local area network. It should be noted that the source entity and the recipient entity can be connected to separate external networks.

According to this second example, the proposed solution is implemented by an access device (connected to the same network as the first device) and the second device, for example a remote server, another access device, another terminal, etc. This second example can notably be implemented when the first device does not support the procedure for selecting at least one packet scheduling policy.

According to a third embodiment, the source entity is an access device connected to a local area network and to at least one external network, routing application data from a first device connected to said local area network, and the recipient entity is a hub, routing application data to a second device connected to at least one external network. As a variant, the source entity is a hub, routing application data from a second device connected to at least one external network, and the recipient entity is an access device connected to a local area network and to at least one external network, routing application data to a first device connected to said local area network. Again, the source entity and the recipient entity can be connected to separate external networks.

According to this third example, the proposed solution is implemented by an access device (connected to the same network as the first device, for example, a terminal) and a hub in communication with a second device, for example, a remote server, another terminal, etc. Such a hub notably makes it possible to aggregate the sub-connections between the access device and the hub, and to terminate these sub-connections. This third example can notably be implemented when neither the first device nor the second device supports the procedure for selecting at least one packet scheduling policy.

According to yet another example, the proposed solution is implemented by a hub and a remote server.

In particular, if the access equipment maintains a long-term connection with a recipient entity, the steps of transmitting and/or receiving lists of PSSs, and subsequently selecting at least one PSS, can be implemented when there is a change of application, or on a regular basis (for example, every 24 hours), or by taking into account changes in the routing conditions of the application data exchanged between the source entity and the recipient entity, etc.

According to a particular embodiment, the access device establishes at least two connections between said source entity and said recipient entity, each implementing a separate packet scheduling policy selected taking into account at least one characteristic of an application.

According to this particular embodiment, the access device can thus establish a connection for an application, with a single packet scheduling policy for the connection considered. As a variant, the access device can establish a connection for several applications, with various packet scheduling policies for the connection considered. In other words, several separate application flows can be routed over the same connection between source and recipient entities, while being subject to separate scheduling policies.

In a particular embodiment, the access device receives information relating to at least one of said external networks from at least one other access device connected to the local area network and having established a connection with the remote server or the hub.

In this way, the access device according to one embodiment of the invention can collect information characteristic of the traffic passing through the other access devices. Such information can notably be used by the access device according to one embodiment of the invention to influence the application procedure (or mode) of the packet scheduling policy selected for the access device and the server-if the server supports the procedure for selecting at least one packet scheduling policy, or the hub-if the server does not support the procedure for selecting at least one packet scheduling policy.

It is considered for example that the various access devices connected to the same local area network can use a “point-to-multipoint” channel established, for example, using a multicast transmission mode, to share between them the information relating to the various external networks.

In another embodiment, the access device transmits to a controller information relating to at least one of said external networks, said controller receiving information relating to at least one of said external networks from at least one other access device connected to said local area network and having established a connection with the remote server or the hub.

In this way, a controller can collect information characteristic of the traffic passing through the other access devices.

It is considered for example that the various access devices connected to the same local area network establish a connection with the controller to share the information relating to the various external networks. Such a controller is for example an SDN controller.

In a particular embodiment, the method according to the invention selects one of said access devices to route said application data from said first device, resp. to said first device, taking into account said information relating to at least one of said external networks.

Such a step can notably be implemented by an access device connected to the local area network or by the controller, for example when several access devices support the procedure for selecting at least one packet scheduling policy according to one embodiment of the invention.

In particular, the selection of one of said access devices also takes into account an identifier associated with said application data.

For example, an application identifier is associated with application data related to an application of a certain type, with particular constraints (for example, low latency). Thus, for example, all application data identified by the same application identifier will pass through the same access device.

In other embodiments, the invention relates to a corresponding source and/or recipient entity.

Such a source, resp. recipient, entity, capable of communicating with a recipient, resp. source, entity, comprises at least one processor configured to:
select, for said source entity and said recipient entity, at least one policy for scheduling application data packets exchanged between said source entity and said recipient entity, taking into account at least one characteristic of an application associated with said application data, said at least one selected packet scheduling policy being supported by said source entity and by said recipient entity,
establish at least one connection between said source entity and said recipient entity implementing said at least one selected packet scheduling policy.

Such an entity is notably suitable for implementing the method for managing data traffic previously described. The source, resp. recipient, entity, could of course support the various characteristics relating to the method according to the invention, which may be combined or taken separately. In this way, the characteristics and advantages of the source, resp. recipient, entity are the same as those of the method according to at least one embodiment of the invention previously described. Therefore, they are not detailed further.

One embodiment of the invention also aims to protect one or more computer programs comprising instructions suitable for implementing at least one step of the method according to at least one embodiment of the invention as described above, when this or these program(s) is/are executed by a processor, as well as at least one computer-readable data medium comprising instructions of at least one computer program as mentioned above.

### BRIEF DESCRIPTION OF THE DRAWINGS

Other characteristics and advantages of the invention will emerge more clearly upon reading the following description of a particular embodiment, provided as a simple illustrative non-restrictive example, and the annexed drawings, wherein:

FIG. 1 illustrates the main steps implemented by a source and/or recipient entity according to at least one embodiment of the invention;

FIG. 2 illustrates an example of a WAN network in which the invention can be implemented,

FIG. 3 illustrates an example of a point-to-multipoint channel established to share information between various access devices connected to the same local area network,

FIGS. 4A to 4B illustrate the selection of an access device as an egress point, taking into account information transported in the channel of FIG. 3,

FIG. 5 illustrates the selection of an access device as an egress point, taking into account an application identifier,

FIG. 6 illustrates an example of a point-to-point channel established to share information between two access devices connected to the same local area network,

FIGS. 7A to 7B illustrate the selection of an access device as an egress point, taking into account the information transported in the channel of FIG. 6,

FIG. 8 shows the simplified structure of a source and/or recipient entity according to a particular embodiment of the invention.

### DETAILED DESCRIPTION OF CERTAIN ILLUSTRATIVE EMBODIMENTS

### General Principle

The general principle of the invention is based on the implementation of a specific packet scheduling policy on a connection established between a source entity and a recipient entity, known as the reference connection. This scheduling policy is based on a mechanism for managing data packets and controlling congestion (similar to a scheduler). Such a packet scheduling policy is chosen taking into account an application generating application data traffic between the source entity and the recipient entity.

It should be noted that such application data represents the data exchanged between a client (for example, a terminal, an access device) and a remote server. The exchange of this application data is therefore based on the establishment of a specific connection, also referred to as an “application” connection, that can be different from the reference connection according to the invention.

The proposed approach is notably based on the use of a packet scheduling policy enabled for a reference connection established between the source entity and the recipient entity.

Thanks to this approach, packet scheduling policies are characteristic of the various applications that are the subject of an exchange of data between the source and recipient entities, which allows a granularity level suitable for the variety of these applications and the traffic profiles. This configuration is therefore not “global”, that is, it is not generic (that is, whatever the number and nature of the applications that lead to the exchange of data between source and recipient entities), nor systemic (that is, the application of the scheduling policies is characteristic of the nature of these various applications, but also of the conditions of access to the networks and the changes in these conditions). In other words, various packet scheduling policies can be dynamically negotiated and implemented for various reference connections established between entities connected to at least one network. In particular, various packet scheduling policies can be implemented for various applications generating traffic between the same source entity and the same recipient entity, that is routed along various routes that connect the source and recipient entities.

In the context of a WAN network interconnecting several local area networks hosted on separate sites of a company, for example, the proposed solution contributes to optimising the use of intra-and inter-site resources, so that traffic routing can reflect the dynamic execution of packet scheduling policies in line with the characteristics of the various applications likely to generate intra-or inter-site traffic (notably in line with the quality of service and/or security requirements of these applications).

According to at least one embodiment, the proposed solution contributes to improving the quality of experience as perceived by a user of a connectivity service. This solution makes it possible in particular to detect (and therefore anticipate) any deterioration in the quality of experience that might be caused for example by network failures (breakdown or overloading of communication links, overloading of switching device, etc.). In addition, the proposed solution does not compromise the integrity of sensitive information and respects its confidentiality. Indeed, no information is shared with an external entity for managing the quality of experience perceived by a user located on a given site.

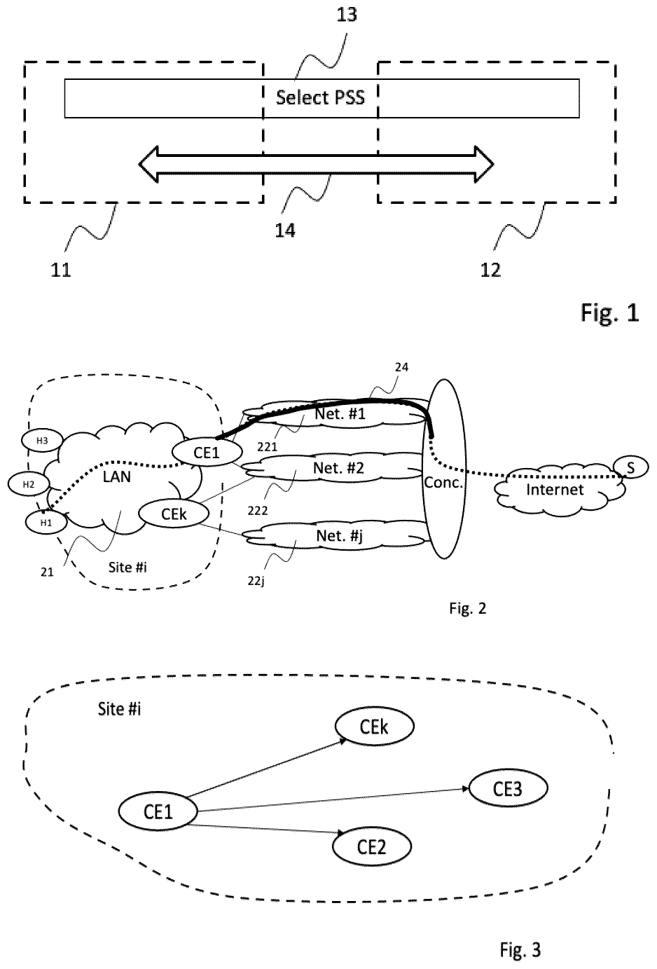

FIG. 1 illustrates the main steps implemented by a source entity 11 and/or a recipient entity 12 according to at least one embodiment of the invention, for managing data traffic between the source entity 11 and the recipient entity 12.

Such a technique for managing data traffic implements a selection 13, for the source entity 11 and the recipient entity 12, of at least one policy (noted for example PSS for “Packet Scheduler SCHEMATICS”) for scheduling application data packets exchanged between the source entity 11 and the recipient entity 12, taking into account at least one characteristic of an application associated with the application data. For example, such a characteristic is of the type maximum transit time, maximum packet loss rate, maintaining the confidentiality of the information exchanged, etc.

In particular, said at least one selected packet scheduling policy is supported by the source entity 11 and by the recipient entity 12. For example, a prior step of checking the capacities of the source entity 11 and/or the recipient entity 12 can be implemented to determine the packet scheduling policy or policies supported by the source entity 11 and by the recipient entity 12.

The technique for managing data traffic according to the invention also implements the establishment 14 of at least one reference connection between the source entity 11 and the recipient entity 12. Such a reference connection is notably configured, established and used to implement the selected packet scheduling policy or policies. These policies can be implemented at the layer responsible for establishing the reference connection (for example, TCP, QUIC) or at other levels (for example, queue management in network interface cards, IP path management). When scheduling policies are configured for a reference connection but their implementation is not (exclusively) the responsibility of the layer responsible for establishing said reference connection, the identifiers of these policies can be exposed via APIs dedicated to accessing the modules responsible for applying these policies.

For example, such a reference connection uses a transport layer protocol, such as the QUIC protocol, that improves the security of exchanges between the source entity and the recipient entity. In other embodiments, the reference connection can be based on the use of another protocol (for example, TCP (with or without the MPTCP option), GRE, GTP, IKE).

As previously indicated, according to a first example, the source (resp. recipient) entity can be a first device, for example a terminal, connected to a local area network, and the recipient (resp. source) entity can be a second device connected to at least one external network, for example a remote server, a second terminal, etc. According to a second example, the source (resp. recipient) entity can be an access device connected to a local area network and to at least one external network, routing application data from (resp. to) a first device connected to the local area network, and the recipient (resp. source) entity can be a second device connected to at least one external network, for example a remote server, a second terminal, etc. According to a third example, the source (resp. recipient) entity can be an access device connected to a local area network and to at least one external network, routing the application data from (resp. to) a first device connected to the local area network, and the recipient (resp. source) entity can be a hub, routing the application data to (resp. from) a second device connected to at least one external network.

Hereinafter, no assumptions are made as to the nature of the entities involved (fixed terminals, mobile terminals, CPE (Customer Premises Equipment), STB (Set-Top Box), access point (hotspot, for example), etc.), as to the architecture of at least one local area network to which at least one of these entities is connected, as to the architecture of a wide area network that connects at least one local area network to which at least one of these entities is connected (fixed or mobile infrastructure, public or private infrastructure, etc.), as to the nature of the network supporting the communications established between local area networks or the communications established on the Internet, etc. For example, the local or wide-area network can be a home network, a company network, a university campus network, an industrial network connecting robots of a site or interconnecting several production sites, etc. Similarly, no assumptions are made as to the nature of the application(s). IP connectivity can notably be provided via a wired network, a wireless network (for example, 5G, Beyond 5G (B5G), 6G), or both.

### Embodiment

### Wide Area Network

A detailed embodiment of the invention is presented below.

For example, a WAN network as illustrated in FIG. 2 interconnecting at least one LAN network 21 (associated for example with a company site #i) and one or more external networks 221, 222, 22j, also referred to as access networks, is considered.

One or more terminals, or hosts, H1, H2, H3 are connected to the LAN 21. One or more access devices, or customer equipment, CE1, CEk are also connected to the LAN 21. These access devices enable the LAN 21 to be connected to at least one of the external networks 221, 222, 22j, to which a server S can be connected.

For example:
one or more access devices can be used to connect a local area network to the same external network: for example, the access devices CE1 and CEk can connect the local area network 21 to the external network Net. #2 222,
the same access device can be used to connect a local area network to several access networks: for example, the access device CE1 can connect the local area network 21 to the external networks Net. #1 221 and Net. #2 222,
one or more access devices can be used to connect a local area network to several access networks: for example, the access devices CE1 and CEk can connect the local area network 21 to the external networks Net. #1 221, Net. #2 222 and Net. #j 22j.

Hereinafter, the term “CE” is used to denote any device connected to a local area network and that can connect said local area network to at least one external (access) network. A CE can notably be a router, or a device that simply forwards traffic to or from the local area network.

A CE can notably be placed under the operational responsibility of the local area network administrator or that of an operator of one of the external networks, etc.

In a particular embodiment, at least one of the external networks 221, 222, 22j can be a wired access network, a cellular access network (5G, B5G, 6G, etc.), a transit network, etc.

In particular, external networks can notably provide global IP connectivity (notably enabling access to the Internet) or restricted connectivity (for example, only to the sites of the same company, access to resources hosted in private or public cloud infrastructures, etc.). Among these various accesses, one or more can be dedicated to the connection of a single site (this is often the case for companies wishing to benefit from exclusive connectivity that is not shared with other entities). It should also be noted that these various accesses can be managed by the same operator or by separate operators.

When considering a WAN network that connects several LAN networks hosted on separate sites of the same company, the communications between the sites of the company can be of various types:
“any-to-any”: the various sites can communicate with each other without any restrictions,
“hub-and-spoke”: “Spoke” sites can communicate with “Hub” sites only, while “Hub” sites can communicate directly with each other,
“hub-spoke-disjoint”: this mode is similar to the “hub-and-spoke” mode, except that “Hubs”cannot communicate with each other.

These engineering choices can be distorted according to the nature of the traffic likely to be exchanged between the sites, the traffic prioritisation policies, the engineering of access to the internal resources of the company when a user is on the move, etc.

The invention notably has applications in these various contexts.

In a particular embodiment, a CE can communicate via all or some of these various external networks with at least one network element, referred to as a “network hub” or a “hub”, via dedicated reference connections typically based on the establishment of tunnels.

No assumptions are made as to the location of a hub.

By way of example, at least one hub 23 can be deployed in at least one of the external networks 221, 222, 22j.

It is considered for example that the first device is a terminal H1, that requires an application hosted by the server S to run. The application data exchanged between the terminal H1 and the server S is transported over an “application” connection between the terminal H1 and the server S, illustrated as a dotted line in FIG. 2.

If both the terminal H1 and the server S support the procedure for selecting at least one packet scheduling policy according to the invention, then traffic distribution between the various external networks can be managed by the terminal H1 and/or the server S. A reference connection according to the invention can then be established between the terminal H1 and the server S. In this case, the application connection and the reference connection can be the same connection.

If the terminal H1 does not support the procedure for selecting at least one packet scheduling policy according to the invention, but the server S does support such a procedure, then traffic distribution can be managed by at least one access device CE1, CEk of the local network and/or the server S. A reference connection according to the invention can then be established between the access device and the server. Such a reference connection can notably be associated with the application connection for routing application data between the terminal and the server via the access device.

If neither the terminal H1 nor the server S supports the procedure for selecting at least one packet scheduling policy according to the invention, then traffic distribution can be managed by at least one access device CE1, CEk of the local area network and/or by at least one hub 23. A reference connection according to the invention can then be established between the access device and the hub. Such a reference connection can notably be associated with the application connection for routing application data between the client and the server via the access device and the hub.

An example of a reference connection 24 between the access device and the hub is notably illustrated as a solid line in FIG. 2.

### Operation of an Access Device and a Hub

For the sake of simplicity, the following is placed in the context where neither the terminal H1 nor the server S supports the procedure for selecting at least one packet scheduling policy. Traffic distribution between the various external networks is therefore managed and executed by at least one access device CE1, CEk of the local area network and/or at least one hub 23, and the selected packet scheduling policy or policies implemented on a reference connection between an access device and a hub, that is therefore different from the application connection established between the terminal H1 and the server S.

It should be noted however that this is just an example, and the steps described below for a CE can more generally be implemented by a source entity and the steps described below for a hub by a recipient entity, for data traffic from the LAN to an external network.

For Data Traffic From the External Network to the Lan, the Source Entity Can be a hub and the recipient entity a CE.

According to the example considered, a CE can be configured with at least one item of information for identifying or reaching at least one hub. Several hub concentrators can be declared to the same CE, for example by means of a static configuration or a dynamic configuration using a protocol such as DHCP or CWMP or NETCONF, to provide the identification/reachability information of the hub(s).

In particular, if the network supporting inter-site communications is an SD-WAN network, that is, a network whose resources are controlled and operated by a logically centralised computing intelligence, typically referred to as an SDN controller, the hub can be an SD-WAN GW gateway.

The information for identifying a hub comprises, for example, one or more IP addresses (IPv4 and/or IPv6), one or more port numbers, and/or an authentication identifier, etc.

According to a first example, an authentication identifier can notably be used to check whether a hub is authorised to establish a reference connection with a CE. This identifier can be checked when a first reference connection is established between the CE and this hub. Such a connection is typically established using dedicated tunnels per available access path established between the CE and the hub.

According to a second example, the addresses and/or port numbers can notably be used as destination addresses and/or port numbers of the reference connections to identify a hub.

As described above, a hub is notably configured to be able to route data received from one CE to another CE to (resp. from) a server located in a public or private cloud, or more generally, to (resp. from) a server connected to the Internet. In addition, a hub can maintain entries in a table, for example a BIB (Binding Information Base), whose entries enable the hub to select the relevant CE to which return traffic will be routed.

### Data Packet Scheduling Policy

As indicated above, notably in relation to the general principle of the invention, at least one data packet scheduling policy (PSS) can be selected for a source entity/recipient entity pair. Such a data packet scheduling policy can notably support all or some of the following functions:
path management,
congestion management,
packet reassembly,
packet reordering,
etc.

A PSS can possibly take into account other parameters for performing the functions previously described, such as:
pricing conditions, set out for example in the contracts drawn up with the operators of the various external networks,
user instructions, for example, minimising costs incurred, balancing path use, etc.,
experience of the use (past, historical) of the resources associated with each external network, which makes it possible, for example, to qualify the stability of certain resources in use and to execute appropriate maintenance policies.

An entity implementing the invention (for example, a CE or a hub) can notably take into account various parameters to select at least one PSS of application data exchanged between the source entity and the recipient entity, taking into account at least one characteristic of an application associated with the application data. For example, an entity implementing the invention can select at least one PSS enabling the use of resources to be adapted, and/or the latency to be optimised, and/or the use of resources to be maximised, and/or their availability to be improved, etc.

An entity implementing the invention (for example a CE or a hub) can notably establish at least one reference connection between the source entity and the recipient entity, on which the selected PSS is implemented. In some embodiments, such a reference connection is based on at least two sub-connections, each associated with a separate path between the source entity and the recipient entity. The choice of the sub-connection(s) used to route the application data can notably depend on the application mode of the selected PSS.

An entity implementing the invention (for example, a CE or a hub) can notably maintain information characteristic of at least one external network, that feeds for example a local function for monitoring and detecting symptoms characteristic of the deterioration in the quality of service or in the quality of experience (QoE) for a given application. Such a function is based, for example, on the use of data that can be processed by artificial intelligence techniques such as machine learning and the use of specific learning algorithms (for example, a reinforcement learning algorithm) and is performed locally (typically supported by a CE). For example, such a function can be used to monitor:
the queue filling rate: monitoring the queues observed on each interface used by a CE to connect to an external network. The queue filling rate can provide a CE with information about the quality of the transmission via the interface concerned. This information can be used to decide on the interfaces to be used to route data depending on the quality of service or QoE needs of a given application, for example,
a one-way transit delay as observed on a path,
a round-trip time RTT as observed on a path, and notably a path providing access to a hub,
a packet loss observed on a path,
an inter-packet delay variation or jitter,
advanced application parameters calculated by robots that emulate some applications (such as a VoIP robot or a Webex® robot for example),
a history of the congestions observed on a path,
etc.

Monitoring the quality of service or the QoE for a given application, for example, from the monitoring function, notably allows the application mode of the selected PSS to be updated. In other words, these various items of information can be used by a CE (resp. a hub) to perform several actions characteristic of the application of a PSS, depending on the quality of service or QoE constraints of the applications, for example. Such actions can consist in executing certain algorithms such as:
round-robin algorithm: the paths (also referred to as “links”) are invoked cyclically depending on an egress point (CE for traffic from the LAN to an external network), associated with each path. For example, the weight of each path can be set by an administrator or calculated (dynamically) depending on several parameters (for example, optimising the costs of the reference connection),
optimising packet storage time in the queues by means of time interval management,
priority-based: priorities are assigned to each path, for example taking into account a PBR (Policy-Based Routing) policy,
an RTT threshold: paths are used until a certain RTT threshold is reached. For example, the threshold is set so that the PSS application can ensure that the paths used do not have an RTT that does not comply with the expectations of the applications. The algorithm(s) involved (notably queue management algorithms) in the application of the PSS notably enable a proactive management of latency deterioration,
a priority assigned to paths with the lowest RTT (“lowest RTT first”): such paths are preferred, for example, to route traffic to a hub,
etc.

Various histograms and statistical distributions can also be maintained for proactive management of quality of service and QoE parameters. Traffic can then be distributed between various paths according to a QoE objective, for example, and not just depending on the QoE observed at a given moment. For example, a CE can:
replicate a portion of the data packets (expressed, for example, as a percentage of total traffic) between several paths for a given period of time,
switch all or part of the traffic to one or more source entities, according to the queue filling rate observed, changes in the RTT parameter, or according to other criteria or symptoms observed by the source entity.

In a particular embodiment, a data packet scheduling policy PSS can be identified by a unique identifier. For example, a PSS can be identified by an integer, a name, etc. PSSs per source entity/recipient entity “pair” can notably be referenced in a register (for example, PSS1 between a given CE and a given hub, PSS2 between a given hub and a given server, PSS3 between a given terminal and a given server).

### Selecting and Implementing a Data Packet Scheduling Policy

Returning to FIG. 2 and the example according to which neither the terminal H1 nor the server S supports the procedure for selecting at least one packet scheduling policy.

When establishing a first reference connection from a CE to a hub, the CE (for example, the CE1) checks whether the hub 23 supports the procedure for selecting at least one packet scheduling policy according to the invention. As a variant, the CE can use a dedicated connection to check whether the hub supports said procedure. This connection is then closed and therefore is not used to transport application data.

For example, a first reference connection using a transport layer protocol, for example QUIC, is established between the CE1 and the hub 23.

According to a particular embodiment, the CE can use a new QUIC transport parameter referred to herein as “Customized PSS” to indicate that the entity transmitting the parameter (CE1 or hub 23, for example) supports the procedure for selecting at least one packet scheduling policy.

For example, a “Customized_PSS” parameter set to “0×1” indicates that the procedure for selecting at least one packet scheduling policy is supported by the entity transmitting the parameter, and a “Customized_PSS” parameter set to “0×0” (or the absence of such a parameter) indicates that the procedure for selecting at least one packet scheduling policy is not supported by the transmitting entity (CE1 or hub 23, for example).

If the source entity (CE1, for example) receives the “Customized PSS” parameter set to “0×1” from the recipient entity (hub 23, for example), the source entity can send the recipient entity a list of packet scheduling policy or policies supported by the source entity.

If the QUIC protocol is used on the first (dedicated or reference) connection established between the source entity and the recipient entity, the source entity can use a new QUIC frame, referred to herein as a QUIC PSS frame, to inform the destination entity of the packet scheduling policy or policies supported by the source entity. The recipient entity can store in memory the list of PSSs supported by the source entity, notably for return traffic management.

The recipient entity can send the source entity a list of packet scheduling policy or policies supported by the recipient entity (notably if the source entity has not communicated to the recipient entity the PSSs supported by the source entity), or a selection of the packet scheduling policies supported by the source entity and the recipient entity.

For example, the source entity receives a list of PSSs supported by the destination entity in a QUIC PSS frame: PSS #1, . . . , PSS #i.

The source entity can notably store in memory the list of PSSs supported by the recipient entity.

For example, the transmission from the recipient entity to the source entity of the list of PSSs supported by the recipient entity can be implemented on a regular basis, for example every 24 hours, to refresh the list of PSSs stored in a memory of the source entity.

It is considered hereafter that at least one common PSS is supported by the source entity and the recipient entity. It is also considered that the source entity and the recipient entity also support at least one same application mode of the PSS.

Among the PSSs supported by the source entity and the recipient entity, at least one PSS is selected taking into account the characteristics of an application associated with the application data exchanged between the source entity and the recipient entity. Such characteristics can notably include the constraints of the application in question.

At least one reference connection, on which at least one selected PSS is implemented, is established between the source entity and the recipient entity (for example, when the source entity is started or restarted, or when the communication characteristic of the application used is established-for example when an HTTP (application) connection is established from a terminal connected to the local area network in which one or more CEs according to the invention are deployed, also referred to as an application connection).

Such a reference connection is based, for example, on the QUIC protocol.

In one embodiment, at least one PSS is selected before the reference connection is established. For example, the source entity selects a PSS to be enabled for the reference connection (associated with an application or a group of applications of the same type) and communicates the PSS identifier to the recipient entity. The source entity and the recipient entity then enable the same PSS for this reference connection. In another embodiment, at least one PSS is selected simultaneously with the reference connection establishment. It should be noted that the same PSS can be applied for one or more reference connections established between the source entity and the recipient entity.

In particular, the reference connection is accepted by the recipient entity if the PSS is supported by the recipient entity. This step of checking the capacity (to support said PSS) is not required if the negotiation of the PSS is performed beforehand between the source entity and the recipient entity, and not when the reference connection is established. The request for establishing a reference connection is rejected if the PSS indicated by the source entity is not supported by the recipient entity or if the “Customized_PSS” parameter set to “0×1” has not been exchanged between the source entity and the recipient entity.

The source entity, for example the CE, can notably establish a reference connection comprising several sub-connections (also referred to as a multi-path connection) with the recipient entity (for example, the hub). As already indicated, the establishment of sub-connections enables traffic to be switched/redirected to one path or another, for example depending on the QoE objectives set by an application or according to changes in transmission conditions (deterioration in transit time, for example).

To do this, for a reference connection for which at least one PSS has been selected, the source entity negotiates with the hub the application mode of the PSS to be executed for the application flows transported over this reference connection. Negotiation is possibly carried out when establishing the communication characteristic of the application used between the terminal and the server, also referred to as an application connection. The data packets transmitted over the reference connection are then distributed between the various paths depending on the application mode of the enabled PSS and according to the quality of service and QoE conditions observed by the source entity.

### Variants

In a particular embodiment, traffic classification information can be provided to the source entity and/or recipient entity to associate a type of application with a packet scheduling policy that would satisfy, for example, the quality requirements related to this type of application.

In other words, the source entity and/or the recipient entity can associate an “application” connection (that transports the application data) with a reference connection on which a PSS selected to meet the quality requirements related to this type of application is implemented.

This classification information can be:
configured by an administrator using a management interface specific to the source and/or recipient entity,
communicated via a signalling mechanism such as the PCP (Port Control Protocol) protocol: a PCP client can then be embedded in a terminal connected to the local area network,
exposed by an application server via a dedicated API: for example, invocation of the API can be conditioned by an agreement between the server provider and the entity managing the communication service (for example, the operator of an SD-WAN network),
indicated via a transport API, for example the API described in document RFC6897 “Multipath TCP (MPTCP) Application Interface Considerations” of March 2013 or “QUIC API for Peer-to-peer Connections” from the W3C Community Group Draft report of 3 Mar. 2022, etc.

Thus, the source entity can notably select the application mode of a PSS to be implemented to associate the traffic received with a pre-established reference connection, or decide to establish a new reference connection, taking into account at least one element belonging to the group comprising:
an item of traffic classification information,
a PSS identifier,
a heuristic local to the source entity,
changes in transmission conditions (for example, deterioration in the latency observed on a reference connection or a sub-connection).

The traffic is then associated with an output interface of the source entity and then routed over the associated sub-connection(s).

It should be noted that the source entity and the recipient entity can use different paths to route outbound traffic and return traffic if the quality of service or QoE objectives are only met in one traffic routing direction (CE to hub or hub to CE), for example.

In particular, if no available path satisfies the quality requirements of an application, the source entity can send an alert to the entity that has management responsibility for it, for example the SDN controller of the site where the source entity is deployed.

The case where the source entity is an access device and the recipient entity is a hub (traffic from the LAN and to an external network) has been described above. Of course, the operations described above can be implemented in the case where the source entity is a hub and the recipient entity is an access device (traffic from the external network and to the LAN). Similarly, the operations described above can be implemented by a first device such as a terminal if it supports a procedure for selecting at least one packet scheduling policy according to the invention, and/or a second device such as another terminal, a server, etc., if it supports a procedure for selecting at least one packet scheduling policy according to the invention. Thus, the source entity can be a terminal and the recipient entity a server (or vice versa), the source entity can be an access device and the recipient entity a server (or vice versa), the source entity can be a hub and the recipient entity a server (or vice versa), the source entity can be an access device and the recipient entity a hub (or vice versa).

### Plurality of Access Devices

A particular embodiment according to which several access devices are connected to the same local area network is described below. In this case, one of the access devices can be selected as the LAN egress point (resp. entry point).

The various CEs connected to the same local area network can notably use a dedicated channel to share with each other information relating to the various external networks, for example, information characteristic of the traffic passing through the CEs connected to the external networks. Such information can notably be used to select one of the CEs connected to the local area network to route application data between the terminal and the server.

According to a first example illustrated in FIG. 3, the dedicated channel can be of the “point-to-multipoint”type.

An access device CE1 can thus receive information relating to at least one of the external networks from at least one other access device CE2, CE3, CEk connected to the local area network and capable of establishing a reference connection with the remote server S or the hub 23. One embodiment of this point-to-multipoint channel is based on a multicast transmission mode, where all CEs subscribe to the same multicast group defined by a particular group address. This multicast address is declared in all the CEs that have subscribed to the same multicast group, for example statically or dynamically using the resources of a protocol such as DHCP or CWMP or NETCONF.

The information received by a CE (for example, the CE2 of FIG. 3) from the other CEs (for example, CE1) can thus feed a path selection procedure implemented by the CE to route the data received from terminals connected to the local area network to one or more hubs. Such information is for example characteristic of the various types of traffic passing through the various CEs, such as {source address; recipient address} pairs.

Thus, this information can be used by at least one CE to change the routing in the local area network for application data traffic in line with the packet scheduling policy selected for the application associated with this application data. This information can notably be used by at least one CE to determine the egress point of the application data traffic depending on various criteria such as the destination of the traffic transmitted by a terminal connected to the local area network, the nature of the traffic transmitted by a terminal connected to the local area network and whose constraints in terms of latency or inter-packet delay variation can impose one path rather than another to reach a hub, etc.

For example, the selection of a CE will be conditioned by its capacity to contribute to compliance with the quality of experience (QoE) level characteristic of the nature of the service or the application used by a terminal connected to the local area network to reach a given destination. To do this, each of the CEs used to reach said destination chooses a preferred path depending on local conditions (access to the service or to a remote site, for example) likely to optimise the QoE as perceived by the user, and announces this path in the local area network. The CE that contributes to providing an optimum QoE will be selected to route traffic to a given destination. It should be noted that the same procedure can be used for default paths («wildcard»:«::/0»(IPv6) or «0.0.0.0/0»(IPv4)).

By way of example, an application connection established between the terminal H2 and the server S is considered.

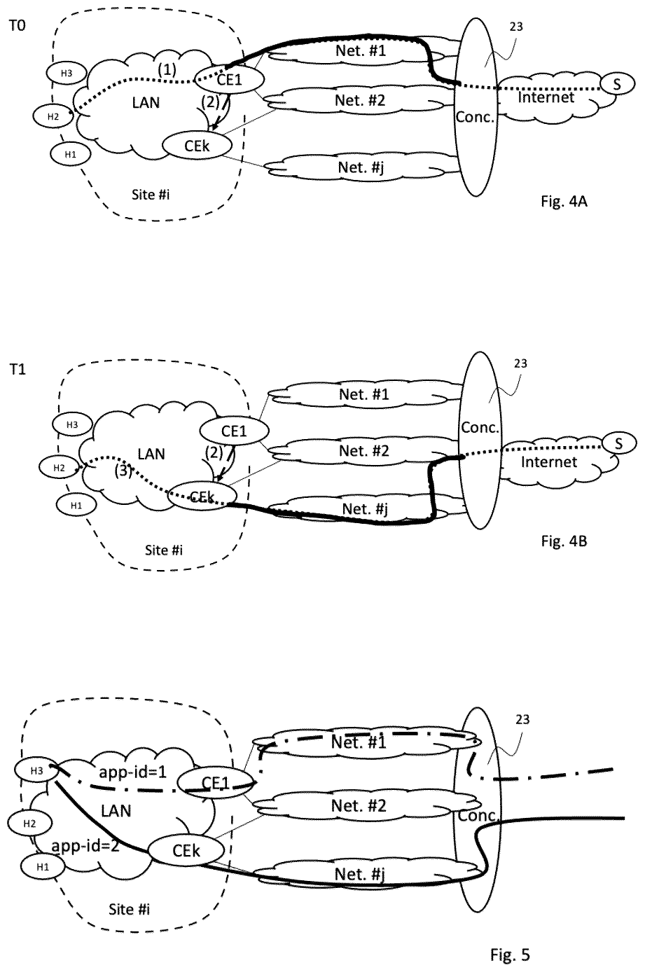

FIGS. 4A and 4B illustrate a first path at a time TO and a second path at a time T1 between the terminal H2 and the server S.

At time TO, illustrated in FIG. 4A, the application connection is associated (for example by the CE1) with a reference connection established between the CE1 and the hub 23. In other words, the application connection transporting the application data between the CE1 and the hub 23 is associated with the reference connection established between the CE and the hub. Application data therefore pass through the access device CE1 and the external network Net. #1. The various access devices CE1 and CEk can notably observe the wide area network (transit time, available bandwidth, traffic profile, etc.) and select an egress point (CE, for traffic from the LAN to an external network) depending on the QoS parameters observed by the CEs and exchanged via the channels established between the CEs of the same site (Site #i).

At time T1, illustrated in FIG. 4B, another egress point (CE) is selected. The application connection is then associated with a reference connection established between the CEk and the hub 23. Data then passes through the access device CEk and the external network Net. #j.

It should be noted that in case the traffic is redirected to another egress point, the continuity of the application connection established between the terminal H2 and the server S can be maintained by the presence of the same hub 23 in the various sub-connections or paths taken by the data passing through this same hub.

In a particular embodiment, the selection of a CE from among several CEs connected to the local area network also takes into account an identifier associated with the application data exchanged between the terminal and the server.

According to a first example, such an identifier is an application identifier, for example “app-id”. The “app-id” identifier can notably be used by a terminal to route packets characteristic of specific applications, also referred to as application data. By way of example, applications with the same QoE constraints can be identified by the same application identifier. For example, an application can communicate its identifier (“app-id”) via a local network API to indicate to a routing/forwarding process embedded in a CE the “application” route to be used to route the data of this application within the local area network. For example, route announcement messages contain an application identifier that makes it possible to maintain specific routes per application in the local area network. In doing so, a local area network can then maintain differentiated routes per application, and therefore, separate CEs can be chosen to route the traffic to the same destination for a given application.

According to other examples, other identifiers can be used to select one route rather than another: for example, the same DSCP (DiffServ Code Point) coding can lead to selecting routes for traffic marked EF (Expedited Forwarding) and other routes for traffic marked AF (Assured Forwarding), without prejudging the nature of the application(s) that will benefit from this differentiated treatment. In this case, a “dscp-val” identifier can be associated with the routes announced between CEs in the messages exchanged between them via a dedicated channel.

By way of example, FIG. 5 illustrates the selection of an egress point (CE1 or CEk, for traffic from the LAN and to an external network) depending on the application (“app-id”) and the QoE parameters observed and exchanged between the CEs of the same site (Site #i). Separate routes are used to route the traffic depending on the application constraints and conditions observed by the various egress points (CEs) connected to the same local area network. For example, a first route via the access device CE1 is preferred for applications identified by the app-id=1 identifier and a second route via the CEk access device is preferred for applications identified by the app-id=2 identifier.

It should be noted that in this embodiment implementing several CEs, in order to avoid contradictory instructions between various CEs of the same site (that is, connected to the same local area network), a CE must inform the other CEs before changing the route.

A first example according to which the dedicated channel can be of the “point-to-multipoint”type has been described above.

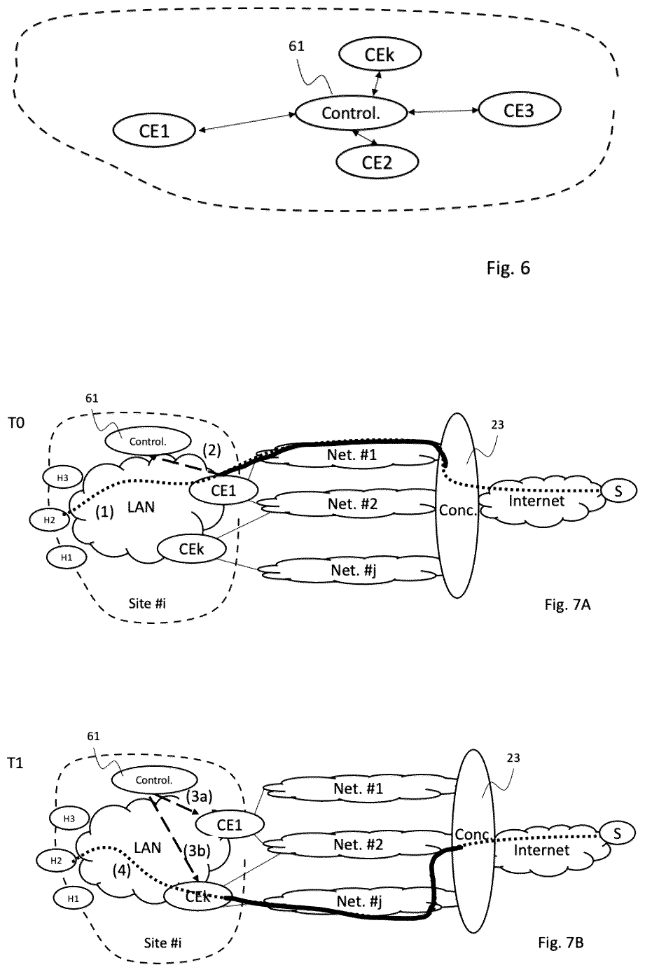

FIG. 6 illustrates a second example according to which the channel dedicated to sharing information between CEs is a “point-to-point”channel.

According to this example, at least one access device connected to the local area network and enabling a reference connection to be established with the remote server S or the hub 23 transmits to a controller 61 information relating to at least one of the external networks to which it is connected. Such information can notably be used to select one of the CEs connected to the local area network to route application data between the terminal and the server.

One example of establishing such a point-to-point channel is to establish a (control) connection between a CE and one or more controllers operated by a company, for example.

Such a controller 61 (SDN controller, for example) can be local to each site. In this way, it is possible to maintain watertight communications between the various sites. Indeed, decisions (routing policies, traffic redirection, site CE management, etc.) taken by such a controller are local to the site. In fact, these decisions do not interfere with those taken by the other controllers deployed on the other sites. Such engineering is also used not to depend on connectivity between the sites, which contributes to increasing robustness and the capacity to apply the decisions taken by the controller, without causing additional delay or compromising the application of the decisions, notably when they have to be taken in response to new quality of service or QE conditions observed on the site considered.

Alternatively, a single controller can be used to manage the various sites where several CEs are deployed. In this case, the controller can associate a CE with its deployment site. This item of information can be configured in the controller by an administrator or retrieved from each CE using a protocol such as NETCONF, for example.

Whichever engineering is chosen (one controller per site or one controller for all sites), the controller uses the information received from the various CEs to decide on the local policy for selecting the egress point(s) within the local area network to route the traffic to a given destination, for all destinations or for a subset of destinations, taking into account several criteria such as the quality of service or QoE conditions, the nature of the traffic, the various traffic profiles, traffic prioritisation policies, etc.

As previously described in relation to FIG. 5, the controller can notably configure the CEs with routes specific to a group of applications with similar quality of service or QoE constraints. For example, the “app-id” identifier can be used to demultiplex the routes and choose egress points (CE, for traffic coming from the LAN and to an external network) per application. The controller can also be responsible for establishing the channel(s) dedicated to sharing information between CEs: exchanging information between CEs via such a point-to-point channel can also involve the controller itself, as the information collected can be used as input data for calculating the routes (and dynamically instantiating the associated “application”routing policy) which will pass through this or that CE.

By way of example, an application connection established between the terminal H2 and the server S is considered. FIGS. 7A and 7B illustrate a first path at a time TO and a second path at a time T1 between the terminal H2 and the server S.

At time T0, illustrated in FIG. 7A, data passes through the access device CE1 and the external network Net. #1. The application connection is associated with a reference connection established between the CE1 and the hub 23. The controller 61 can notably collect information from the various access devices CE1 and CEk and select an egress point (CE, for traffic from the LAN to an external network) depending on the QoS parameters observed by the CEs of the same site (Site #i).

At time T1, illustrated in FIG. 7B, another egress point (CE) is selected. Data then passes through the access device CEk and the external network Net. #j. The application connection is associated with a reference connection established between the CEk and the hub 23.

It should be noted that in case the traffic is redirected to another egress point, the continuity of the application connection established between the terminal H2 and the server S can be maintained by the presence of the same hub 23 in the various sub-connections or various paths taken by the data passing through this same hub.

According to a particular embodiment, the type of channel (point-to-point or point-to-multipoint) for sharing information between CEs can be provided to the various CEs of the same local area network or configured in the various CEs. If no such information is provided to a CE, then the procedure for communicating and sharing information between CEs is disabled by default.

### 5.3 Corresponding Entity

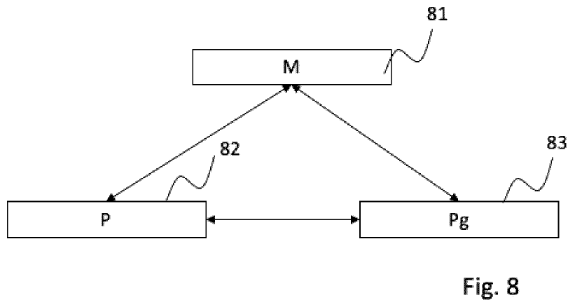

Finally, the simplified structure of a source and/or recipient entity according to one embodiment of the invention is presented in relation to FIG. 8.

The source and/or recipient entity, according to one embodiment of the invention, comprises a memory 81, a processing unit 82, equipped for example with a programmable computing machine or a dedicated computing machine, for example a processor P, and controlled by the computer program 83, implementing steps of the traffic management method according to at least one embodiment of the invention.

At initialisation, the code instructions of the computer program 83 are for example loaded into a RAM memory before being executed by the processor of the processing unit 82.

The processor of the processing unit 82 implements steps of the traffic management method previously described, according to the instructions of the computer program 83, to:
select, for said source entity and said recipient entity, at least one policy for scheduling application data packets exchanged between said source entity and said recipient entity, and taking account at least one characteristic of an application associated with said application data,
said at least one selected packet scheduling policy being supported by said source entity and by said recipient entity,
establish at least one connection between said source entity and said recipient entity, on which said at least one selected packet scheduling policy is implemented.

1. A method of managing data traffic between a source entity and a recipient entity, the method implementing the following steps:
selecting, for the source entity and the recipient entity, at least one policy for scheduling application data packets exchanged between the source entity and the recipient entity, taking into account at least one characteristic of an application associated with the application data,
the at least one selected packet scheduling policy being supported by the source entity and by the recipient entity; and
establishing at least one connection between the source entity and the recipient entity, on which the at least one selected packet scheduling policy is implemented.

2. The method according to claim 1, wherein the source entity transmits to the recipient entity, respectively receives from the recipient entity, a list of at least one packet scheduling policy supported by the source entity.

3. (canceled)

4. The method according to any one of claim 1, wherein the source entity, respectively the recipient entity, transmits a parameter informing the recipient entity, the respective source entity, that it is capable of implementing the at least one selected packet scheduling policy.

5. The method according to claim 2, wherein the list is transmitted using a transport layer protocol between the source entity and the recipient entity.

6. The method according to of claim 1, wherein the connection comprises at least two sub-connections each associated with a separate path between the source entity and the recipient entity, and in that the source entity sends the application data over at least one of the sub-connections, taking into account the at least one packet scheduling policy selected for the connection.

7. The method according to any one of claim 1, wherein the method comprises receiving at least one item of traffic classification information making it possible to associate at least one packet scheduling policy with a type of application.

8. The method according to any one of claim 1, wherein the application mode of the at least one selected packet scheduling policy is updated periodically and/or depending on changes in the routing conditions of the application data exchanged between the source entity and the recipient entity.

9. The method according to any one of claim 1, wherein the source entity, the respective recipient entity, is a first device connected to a local area network, and in that the recipient entity, the respective source entity, is a second device connected to an external network.

10. The method according to any one of claim 1, wherein the source entity, the respective recipient entity, is an access device connected to a local area network and to at least one external network, routing the application data from, respectively to, a first device connected to the local area network, and in that the recipient entity, the respective source entity, is a second device connected to one of the at least one external network.

11. The method according to claim 1, wherein the source entity, the respective recipient entity, is an access device connected to a local area network and to at least one external network, routing the application data from, respectively to, a first device connected to the local area network, and in that the recipient, the respective source, entity is a hub, routing the application data to, respectively from, a second device connected to one of said the at least one external network.

12. The method according to any one of claim 1, wherein the access device establishes at least two connections between the source entity and the recipient entity, each implementing a separate packet scheduling policy selected taking into account at least one characteristic of an application.

13. The method according to claim 10, wherein the access device receives information relating to at least one of the external networks from at least one other access device connected to the local area network and having established a connection with the second device,

14. Method The method according to of claim 10, wherein the access device transmits to a controller information relating to at least one of the external networks, the controller receiving information relating to at least one of the external networks from at least one other access device connected to the local area network and having established a connection with the second device.

15. The method according to claim 13, wherein the method selects one of the access devices to route the application data from the first device, respectively to the first device, taking into account the information relating to at least one of the external networks.

16. The method according to claim 15, wherein the selection of one of the access devices also takes into account an identifier associated with the application data.

17. A source, respective recipient, entity, capable of communicating with a recipient respective source, entity, comprising at least one processor configured to:
select, for the source entity and the recipient entity, at least one policy for scheduling application data packets exchanged between the source entity and the recipient entity, taking into account at least one characteristic of an application associated with the application data,
the at least one selected packet scheduling policy being supported by the source entity and by the recipient entity; and
establish at least one connection between the source entity and the recipient entity on which the at least one selected packet scheduling policy is implemented.

18. The method according to claim 4, wherein the parameter is transmitted using a transport layer protocol between the source entity and the recipient entity.

19. The method according to claim 11, wherein the access device receives information relating to at least one of the external networks from at least one other access device connected to the local area network and having established a connection with the hub.

20. The method according to claim 11, wherein the access device transmits to a controller information relating to at least one of the external networks, the controller receiving information relating to at least one of the external networks from at least one other access device connected to the local area network and having established a connection with the hub.
